(19) United States
(12) Patent Application Publication
(10) Pub. No.: US 2005/0046351 A1
(43) Pub. Date: Mar. 3, 2005

(54) Plasma display panel

(76) Inventor: Tae-Joung Kweon, Suwon-si (KR)

Correspondence Address: MCGUIREWOODS, LLP, 1750 TYSONS BLVD, SUITE 1800, MCLEAN, VA, 22102, US

(21) Appl. No.: 10/922,834

(22) Filed: Aug. 23, 2004

(30) Foreign Application Priority Data
Aug. 26, 2003 (KR) 2003-59142

(51) Int. Cl. H01J 17/49

(52) U.S. Cl. 313/582

(57) ABSTRACT

A plasma display panel (PDP). The PDP includes corresponding pluralities of address and sustaining electrodes provided on respective front and rear substrates. Barrier walls are formed at regular intervals to divide the substrates into individual discharge cells. Respective engaging portions are provided on the address electrodes and on the substrate to which the address electrodes are attached so as to improve the adhesion between the substrate and the address electrodes. In one embodiment, the engaging portions are portions with complementary sets of grooves.

### BACKGROUND OF THE INVENTION

This application claims the priority of Korean Patent Application No. 2003-59142, filed on Aug. 26, 2003, in the Korean Intellectual Property Office, the disclosure of which is incorporated herein in its entirety by reference.

1. Field of the Invention

The present invention relates to a plasma display panel (PDP), and more particularly, to structures and methods for improving adhesion between electrodes and substrates in a PDP.

2. Description of the Related Art

A PDP generates light by using electrical current discharges to excite a fluorescent substance or a particular gas. Within the PDP, two electrodes are set up in a sealed space filled with gas. When a predetermined voltage is applied to the electrodes, a glowing discharge occurs and ultraviolet rays created by the glowing discharge excite fluorescent layers, which are formed in particular patterns, thereby creating an image.

Depending on how it is driven to produce discharges, a PDP can be categorized as a direct current PDP, an alternating current PDP, or a hybrid PDP. A PDP can also be categorized by the number of electrodes it has, for example, a PDPs may use either two or three electrodes. In the case of direct current PDPs, an auxiliary electrode is included to induce an additional discharge. In the case of alternating current PDPs, an address electrode is included to increase the addressing rate by allowing separate address and sustaining discharges.

Additionally, depending on the arrangement of the electrodes, a PDP can be categorized as a facing surfaces discharge PDP or a surface discharge PDP. In the case of a facing surfaces discharge PDP, two sustaining electrodes are provided, one electrode located on a front substrate and the other electrode located on the rear substrate so that a discharge is formed perpendicular to the panel. In the case of a surface discharge PDP, two sustaining electrodes are located on the same substrate so that a discharge is formed on the surface of the substrate.

In such PDPs, the discharge space between the front substrate and the rear substrate is partitioned by barrier walls, which are commonly formed by screen printing or sand blasting. A typical sand blasting method of forming of barrier walls in the conventional PDP is shown in FIG. 1.

As shown in FIG. 1, address electrodes 12 provided in strips are placed at predetermined intervals on a rear substrate 11 and are covered by a rear dielectric layer 13. Each address electrode 12 is covered so that a predetermined length of one end of the address electrode 12 is exposed on one side of the rear dielectric layer 13. The exposed end of the address electrode 12 forms a terminal 12a. A conductive film such as a flexible printed cable (FPC) is pressed onto the terminal 12a making it possible to receive a voltage from an external circuit. (The structure of FIG. 1 includes several address electrodes 12 and several terminals 12a.)

After the address electrodes 12 and the rear dielectric layer 13 are formed on the rear substrate 11, a barrier wall layer 21 of a predetermined height is formed on the rear dielectric layer 13. A photoresist film comprised of a photoresist material is formed on the barrier wall layer 21, completely covering the barrier wall layer 21. A photoresist pattern layer 22 is formed by exposing and developing the photoresist film to pattern it. As shown in FIG. 1, the photoresist pattern layer 22 is formed in strips, allowing barrier walls 23 to be formed between the address electrodes 12. After the photoresist pattern layers 22 are formed, using the sand blast method, abrasives 31 are sprayed onto the barrier wall layer 21 located between the photoresist pattern layers 22 to polish the barrier wall layer 21 so that barrier walls 23 of a predetermined height and width are formed.

In order to polish the barrier wall layer 21 to a predetermined depth, the abrasives 31 are sprayed onto the barrier wall layer 21, and at this point, each address electrode terminal 12a is affected by the spraying pressure from the abrasives 31 because the terminals 12 are exposed. As shown in FIG. 2, since the terminal 12a of the address electrode 12 has a small contact surface with the rear substrate 11, the terminal 12a of the address electrode 12 can be ripped off of the rear substrate 11 because of the spraying pressure from the abrasives 31.

### SUMMARY OF THE INVENTION

One aspect of the present invention provides a plasma display panel. The plasma display panel includes a front substrate, including sustaining electrodes placed at predetermined intervals, a front dielectric layer covering the sustaining electrodes, a rear substrate facing the front substrate and including address electrodes formed orthogonal to the sustaining electrodes, a rear dielectric layer covering the address electrodes, barrier walls which partition discharge spaces between the front substrate and the rear substrate and which have fluorescent layers formed therein; and engaging portions provided on the contacting surfaces between the rear substrate and each of the address electrodes to enhance the adhesion between the rear substrate and the address electrodes.

Another aspect of the present invention provides a plasma display panel. The plasma display panel includes a front substrate, including sustaining electrodes placed at predetermined intervals; a front dielectric layer covering the sustaining electrodes, a rear substrate facing the front substrate and including address electrodes formed in the orthogonal direction of the sustaining electrodes, a rear dielectric layer covering the address electrodes; barrier walls partitioning discharge spaces between the front substrate and rear substrate, engaging portions including first engaging portions formed at positions corresponding to each terminal of the address electrodes on the rear substrate, and second engaging portions formed on one side of each terminal of the address electrodes in junction with the first engaging portions. On one side of the first and second engaging portions, grooves are formed, and on the other side, protrusions are formed which are inserted in the grooves.

Yet another aspect of the invention provides a plasma display panel. The plasma display panel includes a front substrate having sustaining electrodes placed at predetermined intervals, a rear substrate facing the front substrate and including address electrodes formed orthogonal to the sustaining electrodes, barrier walls partitioning discharge spaces between the front substrate and the rear substrate, and the barrier walls having fluorescent materials formed therein. Engaging portions are provided between the rear substrate and each of the address electrodes. Each of the engaging portions has a nonplanar engaging surface.

### BRIEF DESCRIPTION OF THE FIGURES

The above and other features and advantages of the present invention will become more apparent by describing in detail exemplary embodiments thereof with reference to the attached figures in which:

FIG. 1 is a partial perspective view of a process of forming barrier walls in a conventional plasma display panel;

FIG. 2 is a cross sectional view of an address electrode and a rear dielectric layer formed on a rear substrate of FIG. 1;

FIG. 3 is an exploded perspective view of a PDP according to an embodiment of the present invention;

FIG. 4 is a cross sectional view of one example of an address electrode and a rear dielectric layer formed on a rear substrate of FIG. 3;

FIG. 5 is a cross sectional view of another example of the address electrode and the rear dielectric layer formed on the rear substrate of FIG. 3; and

FIG. 6 is a graph of the defect rate according to a contact surface between the rear substrate and the address electrode.

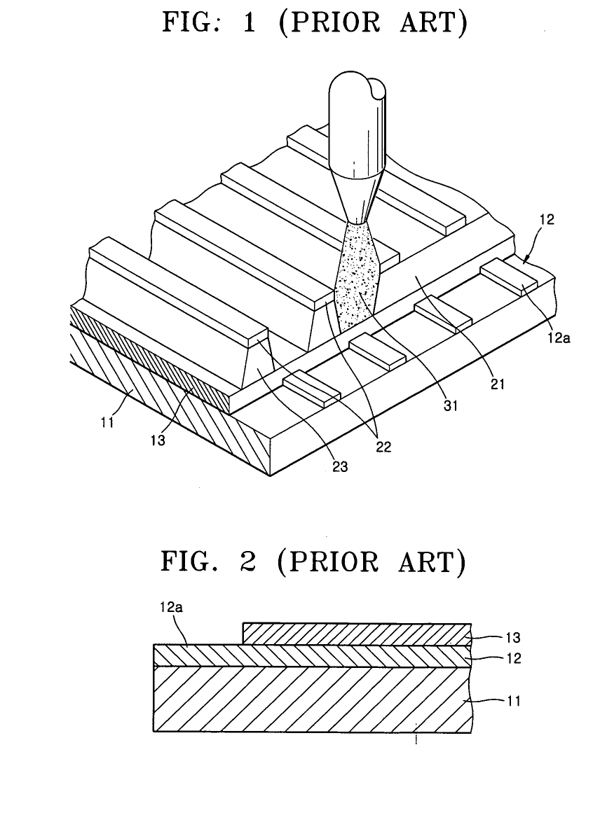

### DETAILED DESCRIPTION OF THE INVENTION

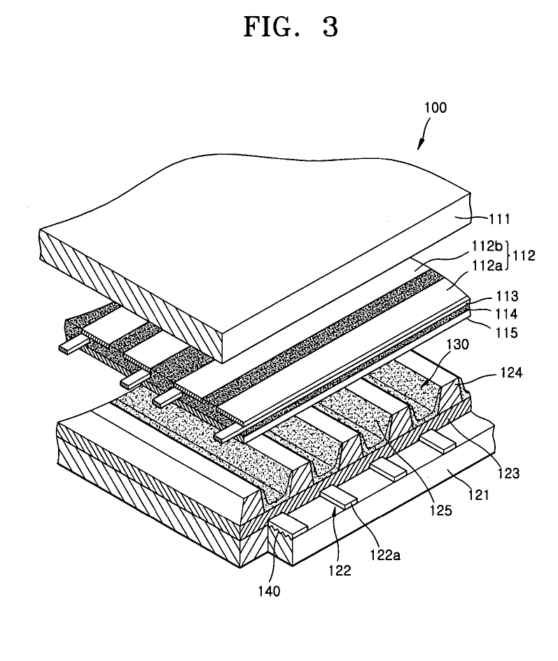

A plasma display panel (PDP) according to a first embodiment of the present invention is shown in FIG. 3. A PDP 100 shown in FIG. 3 includes a front substrate 111, which is made of glass or other transparent material, and a rear substrate 121 that faces the front substrate 111.

A plurality of sustaining electrodes 112 are provided in strips, and bus electrodes 113 are formed under the front substrate 111. The sustaining electrodes 112 may be made of a transparent conductive material, for example, an indium-tin oxide (ITO) film.

The bus electrodes 113 are made of a conductive material, have a width smaller than that of the sustaining electrodes 112, and are arranged beneath each sustaining electrode 112 parallel to the sustaining electrodes 112 to reduce line resistance. In this embodiment, the bus electrode 113 is made of a metal or metal compound that possesses excellent conductivity, such as a silver paste. However, other compounds may be used for the bus electrode 113 in other embodiments.

The sustaining electrode 112 includes a common electrode 112a and a scanning electrode 112b, which alternate in their arrangement. Therefore, one bus electrode 113 is connected to the common electrode 112a and another adjacent bus electrode 113 is connected to the scanning electrode 112b.

The sustaining electrodes 112 and the bus electrodes 113 are buried in a front dielectric layer 114, which is formed on the bottom surface of the front substrate 111. A protective layer 115, for example, an MgO layer, may be formed beneath the front dielectric layer 114.

The rear substrate 121 is arranged to face the front substrate 111 and is generally positioned below the front substrate. The rear substrate 121 is attached to the front substrate 111 by frit glass and the space between the two substrates 111, 121 is filled with an inert gas.

On top of the rear substrate 121, address electrodes 122 are formed and covered by the rear dielectric layer 123. More particularly, a plurality of address electrodes 122 are provided in strips and are placed orthogonal to the bus electrodes 113. The address electrodes 122 are spaced apart at a predetermined interval.

A predetermined length of at least one end of each address electrode 122 is exposed on one side of the rear dielectric layer 123. The exposed address electrodes 122 constitute terminals 122a. A conductive film such as an FPC is pressed on the terminals 122a of the address electrodes 122, enabling the terminals to receive voltage from an external circuit.

On the top of the rear dielectric layer 123, barrier walls 124 are formed such that they are spaced at regular intervals. The barrier walls 124 partition the discharge space located between the front substrate 111 and the rear substrate 121 into individual discharge cells 130.

The barrier walls 124 have a predetermined height and width and are formed in parallel to each other between the address electrodes 122. Each address electrode 122 is placed between two barrier walls 124. The shape of the barrier walls is not limited to what is shown in the drawings. Any form of barrier wall that can partition the discharge cells into a pixel alignment pattern can be employed.

In each discharge cell 130 partitioned by the barrier walls 124, a fluorescent layer 125 comprised of any one of red, green, and blue fluorescent substances is formed. Specifically, a fluorescent layer 125 is formed on the sides of the barrier walls 124 and on the top surface of the rear dielectric layer 123. Each fluorescent layer 125 is either red, green, or blue.

In one embodiment of the present invention, the barrier walls 124 which partition the discharge spaces 130 are formed by a sand blasting method. This method of forming barrier walls 124 will be described in the following.

As a first step, a barrier wall layer is formed on top of the rear dielectric layer 123. The barrier wall layer is of a predetermined height and is made of commonly used barrier wall material. The barrier wall buries the address electrodes 122. Photoresist layers of a predetermined thickness are then formed to completely cover the top surface of the barrier wall layer. The photoresist pattern layers are patterned in strips by a photolithographic process that comprises arranging a pattern mask on top of the photoresist film, exposing the masked photoresist film, and developing the photoresist film. The photoresist pattern layers are formed at locations where barrier walls 124 will be formed. In other words, the photoresist pattern layers are formed at locations that correspond to the top surface of each barrier wall 124. Abrasives are sprayed onto portions where the photoresist layers are not formed, thereby polishing the barrier walls 124 so that they have a predetermined height and width and are formed parallel to the address electrodes 122. After the barrier walls 124 are formed, the photoresist pattern layers are removed by typical photoresist removal methods well-known to those of skill in the art.

When polishing the barrier wall layer with abrasives using the sand blasting method, the abrasives are sprayed not only on the barrier wall layer but also on portions other than the barrier wall layer, such as the terminals 122a of the address electrodes 122, which are exposed from under the rear dielectric layer 123.

In embodiments according to one aspect of the invention, an engaging portion 140 is provided between the rear substrate 121 and the address electrodes 122 to prevent the terminals 122a of the address electrodes 122 from being ripped off from the rear substrate 121 because of the high pressure spraying of the abrasives.

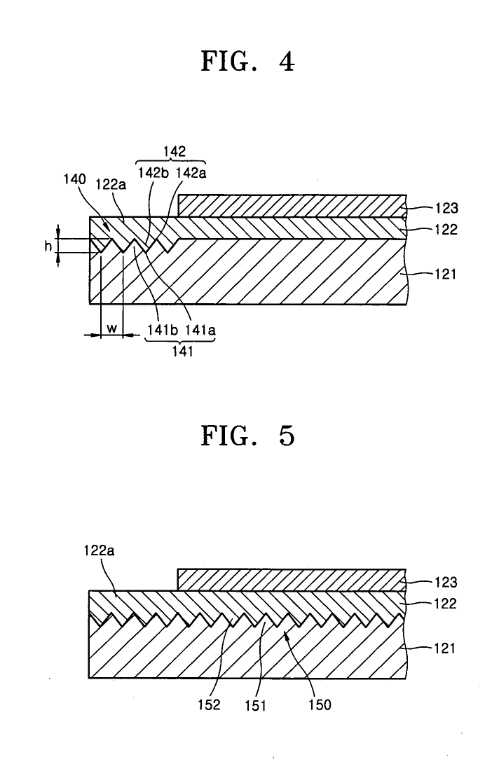

As shown in FIG. 4, an engaging portion 140 is located between the rear substrate 121 and the terminal 122a of the address electrodes 122. The engaging portion increases the adhesive forces between the rear substrate 121 and the terminal 122a. The engaging portion 140 includes a first engaging portion 141 located on the top surface of the rear substrate 121 and a second engaging portion 142 located on the bottom surface of the terminals 122a of the address electrodes 122 corresponding to the first engaging portion 141.

The first engaging portion 141 includes a plurality of V-shaped grooves 141a that are formed on the rear substrate 121. As the grooves 141a are formed, protrusions 141b are created between the grooves 141a. The grooves 141a can be formed on the rear substrate 121 using methods such as etching, a sand blasting, and grinding.

In one embodiment, the grooves 141a of the first engaging portion 141 have a height no less than about 5 μm and no greater than about 30 μm. In that embodiment, the width (W) of the groove 141a would be, for example, no less than about the height (h) of the groove 141a and no greater than about three times of the height (h). In other words, the height (h) of the groove 141a is in a range of about 5 μm≦h≦30 μm, and the width (W) of the groove 141a is in a range of about h≦W≦3 h. As those of ordinary skill in the art will realize, these dimensions are given as one example, and other dimensions may be used in other embodiments of the invention.

The second engaging portion 142, which is engaged with the first engaging portion 141 in which the grooves 141a are formed as mentioned above, consists of protrusions 142b forcibly inserted in the grooves 141a. As shown in FIG. 4, the protrusions 142b are formed in a reversed V-shape to correspond to each groove 141a in the first engaging portion 141 so that when the first and second engaging portions 141, 142 are engaged, a groove 142a is disposed between two protrusions 142b.

The height and width length of the groove 142a in the second engaging portion 142 is the same as the depth and width length of the groove 141a in the first engaging portion 141. Typically, the protrusions 141b of the first engaging portion 141 are forcibly pressed into the grooves 142a of the second engaging portion 142

For example, the protrusions 142b of the second engaging portion 142 may be formed by pressure printing the material used to form the address electrodes 122 against the grooves 141a of the first engaging portion 141 to fill the grooves 141a with the address electrode material.

As the first engaging portion 141 and the second engaging portion 142 are brought into engagement, the contact surface of the rear substrate 121 and the terminal 122a of the address electrode 122 increases, causing the adhesion and junction between the rear substrate 121 and the terminal 122a to be stronger. Therefore, detachment of the terminal 122a of the address electrode 122 from the rear substrate 121 due to the pressure of the abrasive spray can be prevented.

As will be realized by those of skill in the art, the shape of the first engaging portion 141 and second engaging portion 142 are not limited to the above-described V-shapes, and any structure or contour that increases the contact surface between the rear substrate 121 and the terminal 122a of the address electrode 122 may be employed. Additionally, there is no limitation on which of the two engaging portions 141, 142 protrudes and which is grooved; a structure in which the first engaging portions are formed with protrusions and the second engaging portions are formed with grooves is acceptable.

As illustrated in FIG. 5, an engaging portion 150 can be arranged between the surfaces of the rear substrate 121 and the address electrode 122. More specifically, the first engaging portion 151 is formed at a corresponding location to the address electrode 122 which the second engaging portion 152 is formed under the address electrode 122 corresponding to the first engaging portion 151.

The protrusions of the second engaging portion 152 may be formed by pressure printing the material used to form the address electrodes 122 against the grooves of the first engaging portion 151 to fill the grooves with the address electrode material.

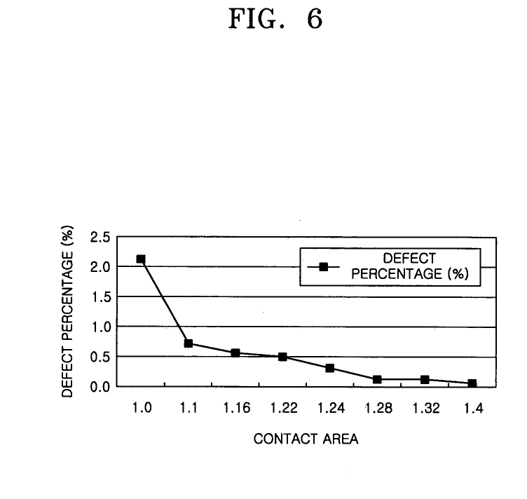

Table 1 shows a comparison between defect rates of a conventional PDP and a PDP having an engaging portion according to an embodiment of the present invention. In addition, Table 1 also shows a comparison between defect rates of the two PDPs according to the contact surface of the rear substrate and address electrode. FIG. 6 shows the defect rate according to the contact surface between the rear substrate and the address electrode.

In Table 1 and FIG. 6, the contact surface according to the present invention is a value relatively defined by the contact surface between the rear substrate and the address electrode when it is assumed that the contact surface between the rear substrate and the address electrode of prior art is 1. The value of a contact surface varies according to the height and width of the grooves of the first and second engaging portions formed on the rear substrate.

As shown in Table 1, the defect rate decreases when the contact surface between the rear substrate and the address electrode is larger than 1 and, as shown in Table 1 and FIG. 6, the defect rate gradually decreases with an increase in the contact surface between the rear substrate and the address electrode.

TABLE 1

| | Width | Height | | |
|---|---|---|---|---|
| | of Groove | of Groove | Contact Surface | Defect Rate |
| Prior Art | 0 | 0 | 1 | 2.1% |
| Present | 50 μm | 5 μm | 1.1 | 0.7% |
| Invention | | 10 μm | 1.16 | 0.55% |
| | | 15 μm | 1.22 | 0.5% |
| | | 20 μm | 1.28 | 0.1% |
| | 50 μm | 10 μm | 1.16 | 0.55% |
| | 60 μm | | 1.24 | 0.3% |
| | 70 μm | | 1.32 | 0.1% |
| | 80 μm | | 1.40 | 0.05% |

As described above, in the PDP according to the present invention, when the barrier walls which partition discharge spaces are formed using sand blasting, since an engaging portion is provided between the rear substrate and address electrodes, the detachment of each end of the address electrodes from the rear substrate can be prevented. Thus, the defect rate is lowered so that yield is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display panel comprising:
a front substrate including sustaining electrodes placed at predetermined intervals;
a front dielectric layer covering the sustaining electrodes;
a rear substrate facing the front substrate and including address electrodes formed orthogonal to the sustaining electrodes;
a rear dielectric layer covering the address electrodes;
barrier walls partitioning discharge spaces between the front substrate and the rear substrate, and which having fluorescent layers formed therein; and
engaging portions provided on the contacting surfaces between the rear substrate and each of the address electrodes to enhance the adhesion between the rear substrate and the address electrodes.

2. The plasma display panel of claim 1, wherein the engaging portions comprise:
one or more first engaging portions formed at positions corresponding to each terminal of the address electrodes on the rear substrate; and
one or more second engaging portions formed on one side of each terminal of the address electrodes, the second engaging portions being complementary to and engageable with the first engaging portions.

3. The plasma display panel of claim 2, wherein one of said first engaging portions and said second engaging portions comprises grooves and another of said first engaging portions and said second engaging portions comprises protrusions inserted into the grooves.

4. The plasma display panel of claim 3, wherein the height of the grooves is between about 5 μm and about 30 μm.

5. The plasma display panel of claim 3, wherein a width of the grooves is in a range having values between about the height and about three times the height.

6. The plasma display panel of claim 1, further comprising:
one or more terminals provided at one end of each address electrode, the one or more terminals being exposed on the rear substrate from the rear dielectric layer;
wherein the engaging portions are provided on the contacting surfaces between the rear substrate and the address electrodes, extending from the edge of the rear dielectric layer to the one or more terminals.

7. The plasma display panel of claim 6, wherein the engaging portions comprise:
one or more first engaging portions formed at positions corresponding to each terminal of the address electrodes on the rear substrate; and
one or more second engaging portions formed on one side of each terminal of the address electrodes, the second engaging portions being complementary to and engageable with the first engaging portions.

8. The plasma display panel of claim 7, wherein one of said first engaging portions and said second engaging portions comprises grooves and another of said first engaging portions and said second engaging portions comprises protrusions inserted into the grooves.

9. The plasma display panel of claim 8, wherein the height of the grooves is between about 5 μm and about 30 μm.

10. The plasma display panel of claim 9, wherein a width of the grooves is in a range having values between about the height and about three times the height.

11. The plasma display panel of claim 1, wherein the barrier walls are formed by sand blasting.

12. A plasma display panel comprising:
a front substrate, including sustaining electrodes placed at predetermined intervals;
a front dielectric layer covering the sustaining electrodes;
a rear substrate, facing the front substrate and including address electrodes formed in an orthogonal direction to the sustaining electrodes;
a rear dielectric layer covering the address electrodes;
barrier walls partitioning discharge spaces between the front substrate and rear substrate; and
engaging portions which include first engaging portions, formed at positions corresponding to each terminal of the address electrodes on the rear substrate, second engaging portions formed on one side of each terminal of the address electrodes and are in junction with the first engaging portions, and wherein on one side of the first and second engaging portions grooves are formed while on the other side protrusions are formed which are inserted in the grooves.

13. The plasma display panel of claim 12, wherein a height of the grooves is between about 5 μm and about 30 μm.

14. The plasma display panel of claim 13, wherein a width of the grooves is in a range having values between about the height of the grooves and about three times the height of the grooves.

15. The plasma display panel of claim 12, wherein the second engaging portion located at the terminal of the address electrode is formed by pressure printing a material used to form the address electrode against the first engaging portion formed on the rear substrate.

16. The plasma display panel of claim 12, wherein the barrier walls are formed by sand blasting.

17. A plasma display panel comprising:
a front substrate including sustaining electrodes placed at predetermined intervals;
a rear substrate facing the front substrate and including address electrodes formed orthogonal to the sustaining electrodes;
barrier walls partitioning discharge spaces between the front substrate and the rear substrate, and which having fluorescent layers formed therein; and
engaging portions provided between the rear substrate and each of the address electrodes, each of the engaging portions having a nonplanar engaging surface.

18. The plasma display panel of claim 17, wherein the engaging portions comprise a first engaging portion provided on the rear substrate and second engaging portions provided on each of the respective address electrodes.

19. The plasma display panel of claim 18, wherein the nonplanar engaging surface includes grooves formed therein.

20. The plasma display panel of claim 19, wherein the grooves of the nonplanar engaging surface of the first engaging portion are complementary to the grooves of the nonplanar engaging surface of the second engaging portion.
